(19) United States
(12) Patent Application Publication
(10) Pub. No.: US 2025/0048437 A1
(43) Pub. Date: Feb. 6, 2025

(54) LATENCY AND INTERRUPTION INFORMATION FOR LAYER-1/2-TRIGGERED MOBILITY

(71) Applicant: QUALCOMM Incorporated, San Diego, CA (US)

(72) Inventors: Changhwan PARK, San Diego, CA (US); Mona AGRAWAL, San Diego, CA (US); Yan ZHOU, San Diego, CA (US); Tao LUO, San Diego, CA (US)

(21) Appl. No.: 18/783,987

(22) Filed: Jul. 25, 2024

Related U.S. Application Data
(60) Provisional application No. 63/517,774, filed on Aug. 4, 2023.

(51) Int. Cl. H04W 74/0833

(52) U.S. Cl. CPC H04W 74/0833

(57) ABSTRACT

Various aspects of the present disclosure generally relate to wireless communication. In some aspects, a user equipment (UE) may receive layer-1/2-triggered mobility (LTM)-based configurations of one or more neighbor cells. The UE may transmit an indication of one or more of a set of one or more latencies or a set of interruption information in association with transmitting random access channel (RACH) communications associated with respective configurations of the LTM-based configurations of the one or more neighbor cells. Numerous other aspects are described.

### CROSS-REFERENCE TO RELATED APPLICATION

This patent application claims priority to U.S. Provisional Patent Application No. 63/517,774, filed on Aug. 4, 2023, entitled “LATENCY AND INTERRUPTION INFORMATION FOR LAYER-1/2-TRIGGERED MOBILITY,” and assigned to the assignee hereof. The disclosure of the prior Application is considered part of and is incorporated by reference into this patent application.

### FIELD OF THE DISCLOSURE

Aspects of the present disclosure generally relate to wireless communication and to techniques and apparatuses for latency and interruption information for layer-1/2-triggered mobility.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

A handover procedure may allow a user equipment (UE) to move from a first cell to a second cell based at least in part on layer 1 and/or layer 2 (L1/L2) measurements. For example, the UE may be configured with a set of multiple configurations associated with multiple neighbor cells. A serving cell may transmit (e.g., in association with the UE providing an indication based at least in part on the L1/L2 measurements) an L1/L2 indication (e.g., via a control channel) to transmit signaling to one or more of the multiple neighbor cells. In this way, the UE does not need to wait for a radio resource control (RRC) occasion to receive an indication of one or more configurations for transmitting the signaling to the one or more of the multiple neighbor cells. However, during an interruption time associated with transmitting the signaling, communications between the serving cell and the UE may be disrupted. This may cause communication errors, skipping in a stream of data, and/or a loss of an application layer connection, among other examples. The network node may not be aware of a duration of the interruption time based at least in part on being unaware of UE capabilities associated with tuning, processing, and/or retuning to the serving cell, among other examples.

Various aspects relate generally to L1/L2 triggered mobility (LTM)-based communications. Some aspects more specifically relate to interruptions of communications between a UE and a serving cell in association with an LTM-based communication. In some examples, a UE may receive LTM-based configurations of one or more neighbor cells. The UE may identify latency and/or interruption information (e.g., interruption lengths, interruption starting times, and/or affected cells and/or bands, among other examples) associated with the LTM-based configurations (e.g., different values associated with individual LTM-based configurations) and indicate the latency and/or interruption information to a network node associated with a serving cell. In this way, the network node may identify a minimum interruption and/or latency for the UE to transmit a random access channel (RACH) communication to a neighbor cell of the one or more neighbor cells and return to availability for communications via the serving cell. In some examples, based at least in part on the UE indicating the latency and/or the interruption information to the network node, the described techniques can be used to improve latency for the UE to transmit RACH communications to neighbor cells and/or reduce an interruption length for communications with the UE via the serving cell, in association with transmitting the RACH communications.

Some aspects described herein relate to a method of wireless communication performed by a UE. The method may include receiving LTM-based configurations of one or more neighbor cells. The method may include transmitting an indication of one or more of a set of one or more latencies or a set of interruption information in association with transmitting RACH communications associated with respective configurations of the LTM-based configurations of the one or more neighbor cells.

Some aspects described herein relate to a method of wireless communication performed by a network node. The method may include transmitting, to a UE, LTM-based configurations of one or more neighbor cells. The method may include receiving an indication of one or more of a set of one or more latencies or a set of interruption information in association with the UE transmitting RACH communications associated with respective configurations of the LTM-based configurations of the one or more neighbor cells.

Some aspects described herein relate to a UE for wireless communication. The user equipment may include one or more memories and one or more processors coupled to the one or more memories. The one or more processors may be configured to receive LTM-based configurations of one or more neighbor cells. The one or more processors may be configured to transmit an indication of one or more of a set of one or more latencies or a set of interruption information in association with transmitting RACH communications associated with respective configurations of the LTM-based configurations of the one or more neighbor cells.

Some aspects described herein relate to a network node for wireless communication. The network node may include one or more memories and one or more processors coupled to the one or more memories. The one or more processors may be configured to transmit, to a UE, LTM-based configurations of one or more neighbor cells. The one or more processors may be configured to receive an indication of one or more of a set of one or more latencies or a set of interruption information in association with the UE transmitting RACH communications associated with respective configurations of the LTM-based configurations of the one or more neighbor cells.

Some aspects described herein relate to a non-transitory computer-readable medium that stores a set of instructions for wireless communication by a UE. The set of instructions, when executed by one or more processors of the UE, may cause the UE to receive LTM-based configurations of one or more neighbor cells. The set of instructions, when executed by one or more processors of the UE, may cause the UE to transmit an indication of one or more of a set of one or more latencies or a set of interruption information in association with transmitting RACH communications associated with respective configurations of the LTM-based configurations of the one or more neighbor cells.

Some aspects described herein relate to a non-transitory computer-readable medium that stores a set of instructions for wireless communication by a network node. The set of instructions, when executed by one or more processors of the network node, may cause the network node to transmit, to a UE, LTM-based configurations of one or more neighbor cells. The set of instructions, when executed by one or more processors of the network node, may cause the network node to receive an indication of one or more of a set of one or more latencies or a set of interruption information in association with the UE transmitting RACH communications associated with respective configurations of the LTM-based configurations of the one or more neighbor cells.

Some aspects described herein relate to an apparatus for wireless communication. The apparatus may include means for receiving LTM-based configurations of one or more neighbor cells. The apparatus may include means for transmitting an indication of one or more of a set of one or more latencies or a set of interruption information in association with transmitting RACH communications associated with respective configurations of the LTM-based configurations of the one or more neighbor cells.

Some aspects described herein relate to an apparatus for wireless communication. The apparatus may include means for transmitting, to a UE, LTM-based configurations of one or more neighbor cells. The apparatus may include means for receiving an indication of one or more of a set of one or more latencies or a set of interruption information in association with the UE transmitting RACH communications associated with respective configurations of the LTM-based configurations of the one or more neighbor cells.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example of a Layer 1/Layer 2 (L1/L2) triggered mobility (LTM) procedure, in accordance with the present disclosure.

FIG. 5 is a diagram illustrating an example of UE mobility, in accordance with the present disclosure.

FIG. 6 is a diagram of an example associated with latency and interruption information for LTM, in accordance with the present disclosure.

FIG. 7 is a diagram illustrating an example process performed, for example, at a UE or an apparatus of a UE, in accordance with the present disclosure.

FIG. 8 is a diagram illustrating an example process performed, for example, at a network node or an apparatus of a network node, in accordance with the present disclosure.

FIG. 9 is a diagram of an example apparatus for wireless communication, in accordance with the present disclosure.

FIG. 10 is a diagram of an example apparatus for wireless communication, in accordance with the present disclosure.

### DETAILED DESCRIPTION

A handover procedure may allow a user equipment (UE) to move from a first cell to a second cell based at least in part on layer 1 and/or layer 2 (L1/L2) measurements. For example, the UE may be configured with a set of multiple configurations associated with multiple neighbor cells. A serving cell may transmit (e.g., in association with the UE providing an indication based at least in part on the L1/L2 measurements) an L1/L2 indication (e.g., via a control channel) to transmit signaling to one or more of the multiple neighbor cells. In this way, the UE does not need to wait for a radio resource control (RRC) occasion to receive an indication of one or more configurations for transmitting the signaling to the one or more of the multiple neighbor cells. However, during an interruption time associated with transmitting the signaling, communications between the serving cell and the UE may be disrupted. This may cause communication errors, skipping in a stream of data, and/or a loss of an application layer connection, among other examples. The network node may not be aware of a duration of the interruption time based at least in part on being unaware of UE capabilities associated with tuning, processing, and/or retuning to the serving cell, among other examples.

Various aspects relate generally to LTM-based communications. Some aspects more specifically relate to interruptions of communications between a UE and a serving cell in association with an LTM-based communication. In some examples, a UE may receive LTM-based configurations of one or more neighbor cells. The UE may identify latency and/or interruption information associated with the LTM-based configurations (e.g., different values associated with individual LTM-based configurations) and indicate the latency and/or interruption information to a network node associated with a serving cell. In this way, the network node may identify a minimum interruption and/or latency for the UE to transmit a RACH communication to a neighbor cell of the one or more neighbor cells and return to availability for communications via the serving cell. In some aspects, a neighbor cell may include one or more secondary cells (SCells) of a serving cell (e.g., the UE may attempt to promote an SCell to a primary cell (PCell)) or a non-serving cell.

Particular aspects of the subject matter described in this disclosure can be implemented to realize one or more of the following potential advantages. In some examples, by the UE indicating the latency and/or the interruption information to the network node, the described techniques can be used to improve latency for the UE to transmit RACH communications to neighbor cells and/or reduce an interruption length for communications with the UE via the serving cell, in association with transmitting the RACH communications.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

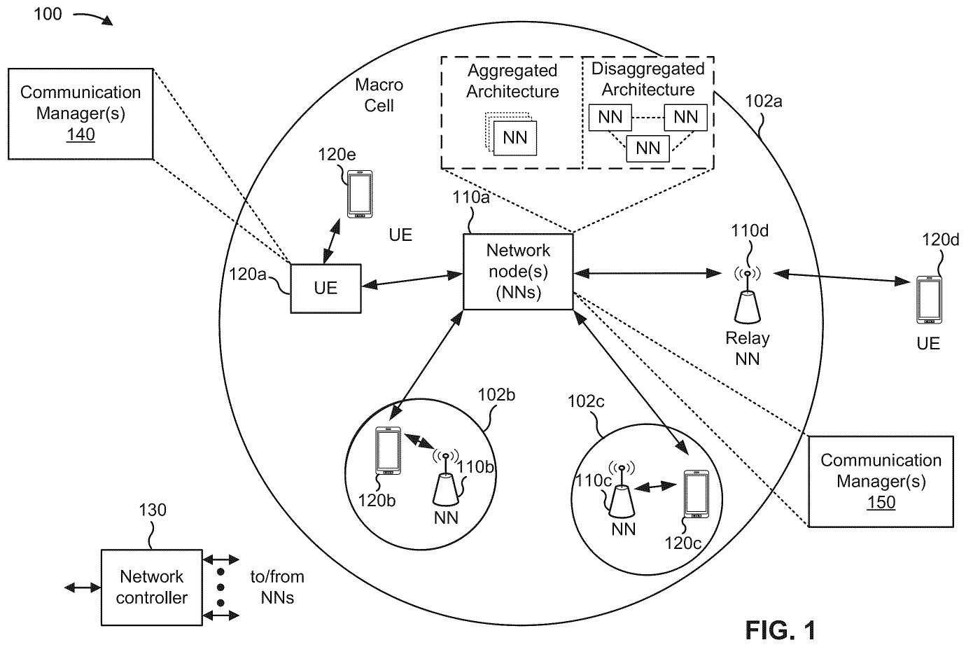

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a UE 120 or multiple UEs 120 (shown as a UE 120a, a UE 120b, a UE 120c, a UE 120d, and a UE 120c), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, an unmanned aerial vehicle, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120c) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FRI, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may receive layer-1/2-triggered mobility (LTM)-based configurations of one or more neighbor cells; and transmit an indication of one or more of a set of one or more latencies or a set of interruption information in association with transmitting random access channel (RACH) communications associated with respective configurations of the LTM-based configurations of the one or more neighbor cells. Additionally, or alternatively, the communication manager 140 may perform one or more other operations described herein.

In some aspects, the network node 110 may include a communication manager 150. As described in more detail elsewhere herein, the communication manager 150 may transmit, to a UE, LTM-based configurations of one or more neighbor cells; and receive an indication of one or more of a set of one or more latencies or a set of interruption information in association with the UE transmitting RACH communications associated with respective configurations of the LTM-based configurations of the one or more neighbor cells. Additionally, or alternatively, the communication manager 150 may perform one or more other operations described herein.

As indicated above, FIG. 1 is provided as an example. Other examples may differ from what is described with regard to FIG. 1.

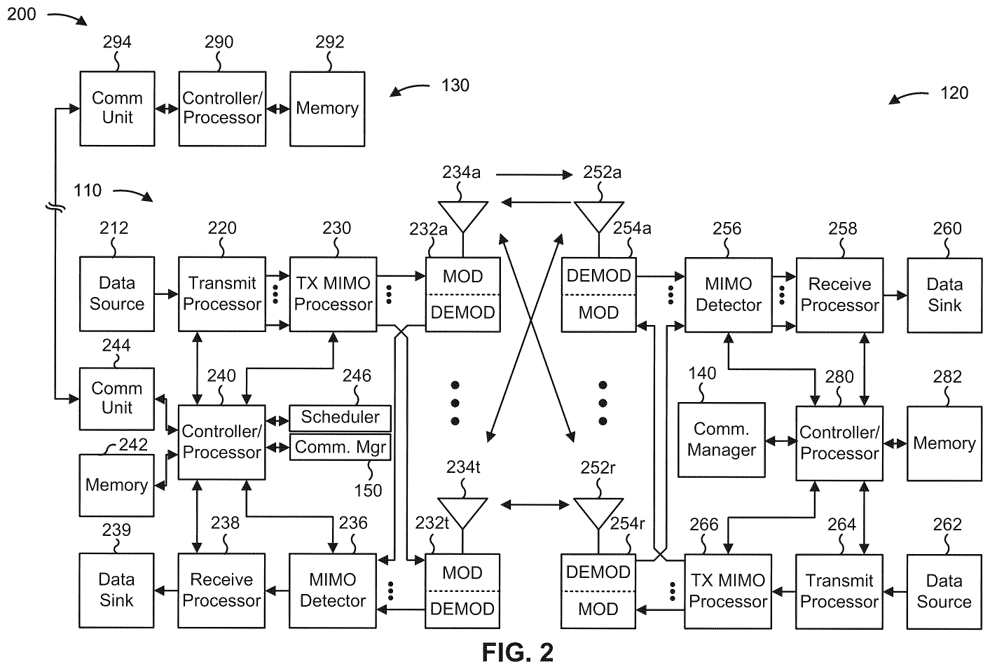

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

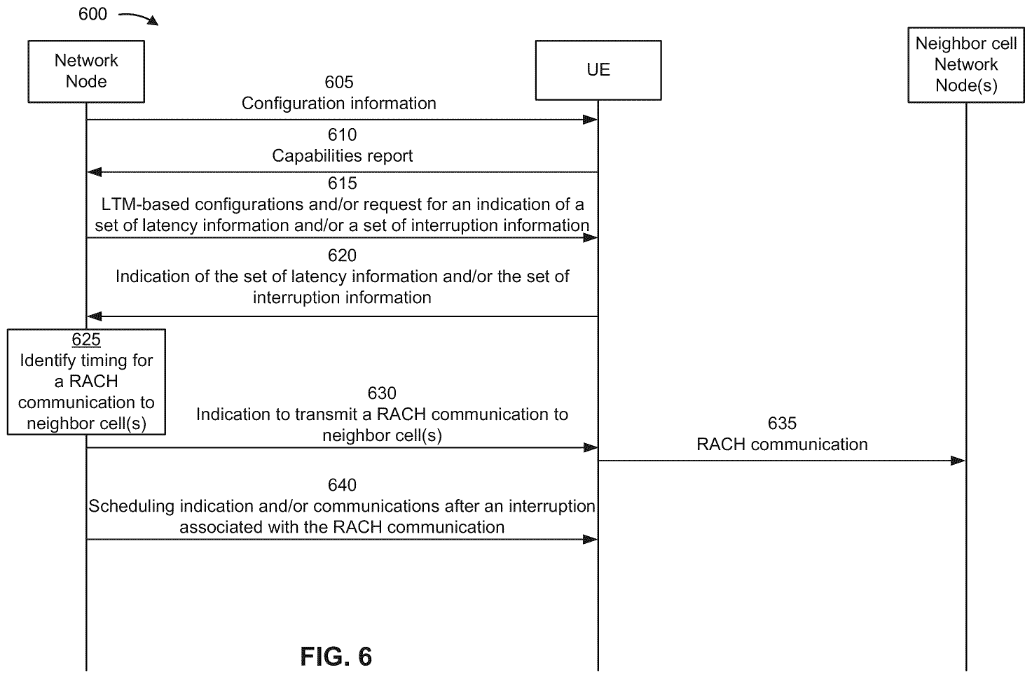

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 6-10).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 6-10).

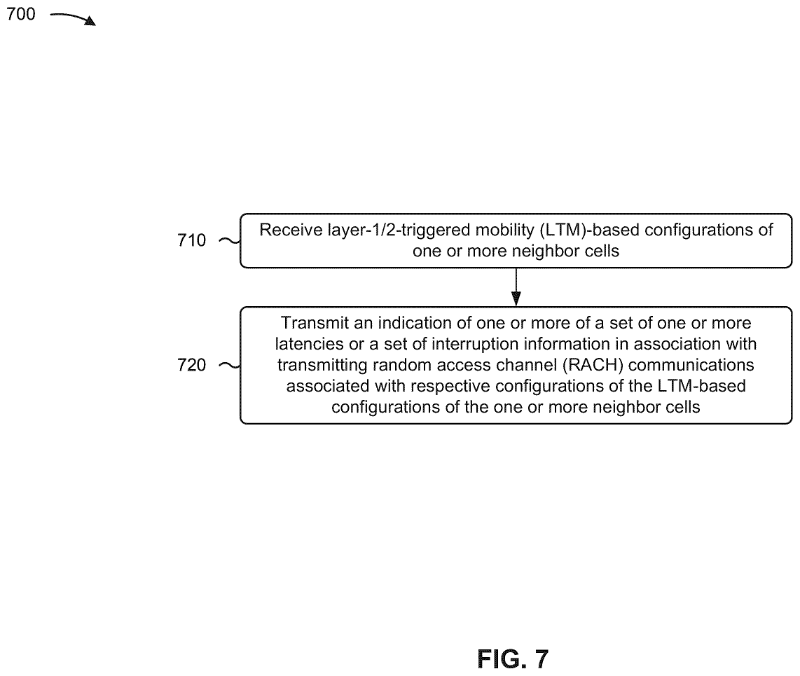

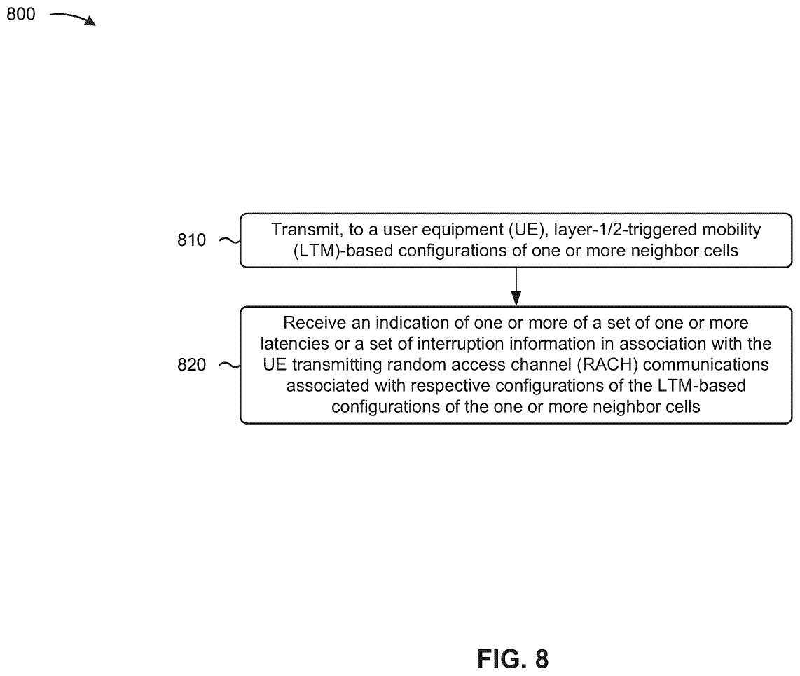

The controller/processor 240 of the network node 110, the controller/processor 280 of the UE 120, and/or any other component(s) of FIG. 2 may perform one or more techniques associated with latency and interruption information for LTM, as described in more detail elsewhere herein. For example, the controller/processor 240 of the network node 110, the controller/processor 280 of the UE 120, and/or any other component(s) of FIG. 2 may perform or direct operations of, for example, process 700 of FIG. 7, process 800 of FIG. 8, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 700 of FIG. 7, process 800 of FIG. 8, and/or other processes as described herein. In some examples, executing instructions may include running the instructions, converting the instructions, compiling the instructions, and/or interpreting the instructions, among other examples.

In some aspects, the UE includes means for receiving LTM-based configurations of one or more neighbor cells; and/or means for transmitting an indication of one or more of a set of one or more latencies or a set of interruption information in association with transmitting RACH communications associated with respective configurations of the LTM-based configurations of the one or more neighbor cells. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node includes means for transmitting, to a UE, LTM-based configurations of one or more neighbor cells; and/or means for receiving an indication of one or more of a set of one or more latencies or a set of interruption information in association with the UE transmitting RACH communications associated with respective configurations of the LTM-based configurations of the one or more neighbor cells. The means for the network node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

In some aspects, an individual processor may perform all of the functions described as being performed by the one or more processors. In some aspects, one or more processors may collectively perform a set of functions. For example, a first set of (one or more) processors of the one or more processors may perform a first function described as being performed by the one or more processors, and a second set of (one or more) processors of the one or more processors may perform a second function described as being performed by the one or more processors. The first set of processors and the second set of processors may be the same set of processors or may be different sets of processors. Reference to “one or more processors” should be understood to refer to any one or more of the processors described in connection with FIG. 2. Reference to “one or more memories” should be understood to refer to any one or more memories of a corresponding device, such as the memory described in connection with FIG. 2. For example, functions described as being performed by one or more memories can be performed by the same subset of the one or more memories or different subsets of the one or more memories.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (CNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

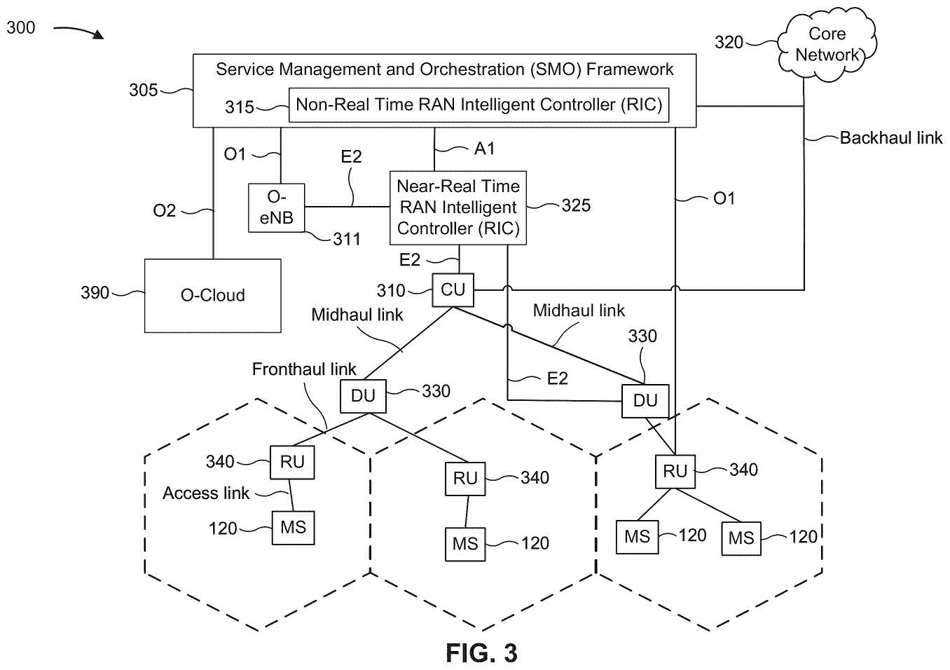

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (IFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an Al interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

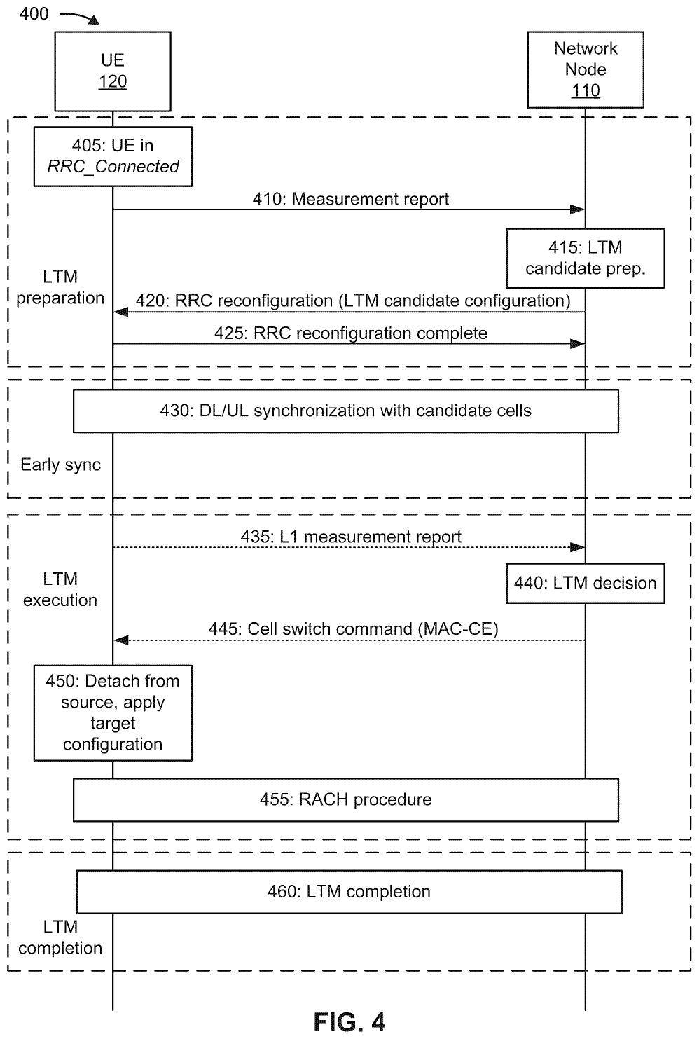

FIG. 4 is a diagram illustrating an example 400 of a Layer 1/Layer 2 (L1/L2) triggered mobility (LTM) procedure, in accordance with the present disclosure.

In some examples, a network node 110 may instruct a UE 120 to change serving cells, such as when the UE 120 moves away from coverage of a current serving cell (sometimes referred to as a source cell) and towards coverage of a neighbor cell (sometimes referred to as a target cell). In some cases, the network node 110 may instruct the UE 120 to change cells using a layer 3 (L3) handover procedure. An L3 handover procedure may include the network node 110 transmitting, to the UE 120, an RRC reconfiguration message indicating that the UE 120 should perform a handover procedure to a target cell, which may be transmitted in response to the UE 120 providing the network node 110 with an L3 measurement report indicating signal strength measurements associated with various cells (e.g., measurements associated with the source cell and one or more neighbor cells). In response to receiving the RRC reconfiguration message, the UE 120 may communicate with the source cell and the target cell to detach from the source cell and connect to the target cell (e.g., the UE 120 may establish an RRC connection with the target cell). Once handover is complete, the target cell may communicate with a user plane function (UPF) of a core network to instruct the UPF to switch a user plane path of the UE 120 from the source cell to the target cell. The target cell may also communicate with the source cell to indicate that handover is complete and that the source cell may be released.

L3 handover procedures may be associated with high latency and high overhead due to the multiple RRC reconfiguration messages and/or other L3 signaling and operations used to perform the handover procedures. Accordingly, in some examples, a UE 120 may be configured to perform a lower-layer (e.g., L1 and/or L2) handover procedure, sometimes referred to an LTM procedure, such as the example 400 LTM procedure shown in FIG. 4. As shown in FIG. 4, the LTM procedure may include four phases: an LTM preparation phase, an early synchronization phase (shown as “early sync” in FIG. 4), an LTM execution phase, and/or an LTM completion phase.

During the LTM preparation phase, and as shown by reference number 405, the UE 120 may be in an RRC connected state (sometimes referred to as RRC_Connected) with a source cell. As shown by reference number 410, the UE 120 may transmit, and the network node 110 may receive, a measurement report (sometimes referred to as a MeasurementReport), which may be an L3 measurement report. The measurement report may indicate signal strength measurements (e.g., RSRP, RSSI, RSRQ, and/or CQI) or similar measurements associated with the source cell and/or one or more neighbor cells. In some examples, based at least in part on the measurement report or other information, the network node 110 may decide to use LTM, and thus, as shown by reference number 415, the network node 110 may initiate LTM candidate preparation.

As shown by reference number 420, the network node 110 may transmit, and the UE 120 may receive, an RRC reconfiguration message (sometimes referred to as an RRCReconfiguration message), which may include an LTM candidate configuration. More particularly, the RRC reconfiguration message may indicate a configuration of one or more LTM candidate target cells, which may be candidate cells to become a serving cell of the UE and/or cells for which the UE 120 may later be triggered to perform an LTM procedure. As shown by reference number 425, the UE 120 may store the configuration of the one or more LTM candidate cell configurations and, in response, may transmit, to the network node 110, an RRC reconfiguration complete message (sometimes referred to as an RRCReconfigurationComplete message).

During the early synchronization phase, and as shown by reference number 430, the UE 120 may optionally perform downlink/uplink synchronization with the candidate cells associated with the one or more LTM candidate cell configurations. For example, the UE 120 may perform downlink synchronization and timing advance acquisition with the one or more candidate target cells prior to receiving an LTM switch command (which is described in more detail below in connection with reference number 445). In some aspects, performing the early synchronization with the one or more candidate cells may reduce latency associated with performing a RACH procedure later in the LTM procedure, which is described in more detail below in connection with reference number 455.

During the LTM execution phase, and as shown by reference number 435, the UE 120 may perform L1 measurements on the configured LTM candidate target cells, and thus may transmit, to the network node 110, lower-layer (e.g., L1) measurement reports. As shown by reference number 440, based at least in part on the lower-layer measurement reports, the network node 110 may decide to execute an LTM cell switch to a target cell. Accordingly, as shown by reference number 445, the network node 110 may transmit, and the UE 120 may receive, a MAC control element (MAC-CE) or similar message triggering an LTM cell switch (the MAC-CE or similar message is sometimes referred to herein as a cell switch command). The cell switch command may include an indication of a candidate configuration index associated with the target cell. As shown by reference number 450, based at least in part on receiving the cell switch command, the UE 120 may switch to the configuration of the LTM candidate target cell (e.g., the UE 120 may detach from the source cell and apply the target cell configuration). Moreover, as shown by reference number 455, the UE 120 may perform a RACH procedure towards the target cell, such as when a timing advance associated with the target cell is not available (e.g., in examples in which the UE 120 did not perform the early synchronization as described above in connection with reference number 430).

During the LTM completion phase, and as shown by reference number 460, the UE 120 may indicate successful completion of the LTM cell switch towards the target cell. In this way, cell switch to a target cell may be performed using less overhead than for an L3 handover procedure and/or a cell switch to a target cell may be associated with reduced latency as compared to L3 handover procedure.

As indicated above, FIG. 4 is provided as an example. Other examples may differ from what is described with respect to FIG. 4.

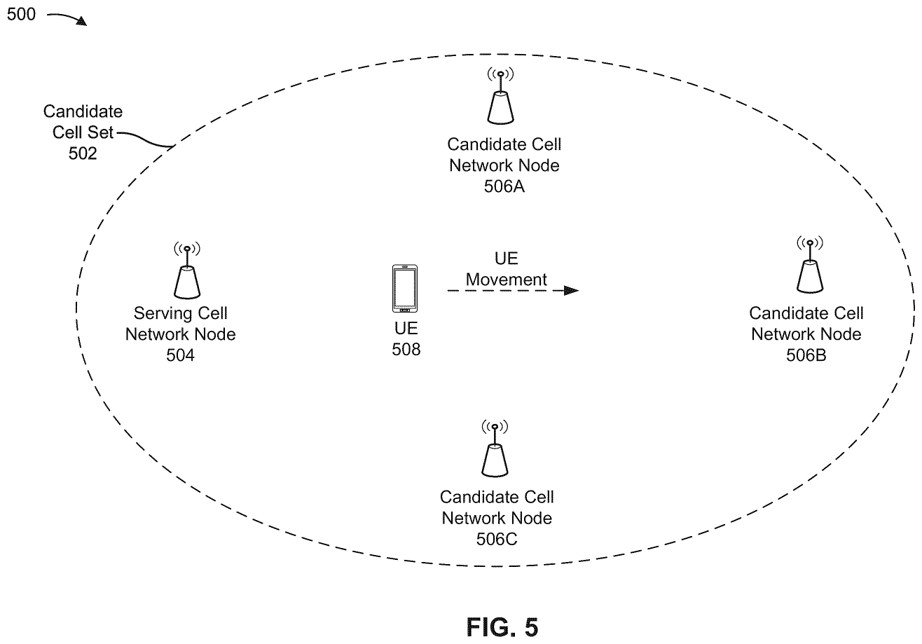

FIG. 5 is a diagram illustrating an example 500 of UE mobility, in accordance with the present disclosure. As shown in FIG. 5, a network may include a candidate cell set 502 that includes cells provided by a serving cell network node 504 (e.g., a serving cell) and a set of candidate cells provided by a set of candidate cell network nodes 506A, 506B, and 506C.

A UE 508 is located within coverage of the candidate cell set 502 and is in communication with the serving cell network node 504. While in communication with the serving cell network node 504, UE movement away from the serving cell network node 504 may cause the UE 508 to have reduced signal strength and/or capacity via the serving cell and may cause the UE 508 to have increased signal strength and/or capacity via a candidate cell, such as a candidate cell associated with the candidate cell network node 506B.

In some networks, a special cell (SpCell) for the UE may be updated via L1/L2 signaling based at least in part on L1 measurement of the serving cell and the candidate cell. In some networks, UE mobility (e.g., moving from one cell to another cell) may include intra-frequency and inter-frequency mobility.

As indicated above, FIG. 5 is provided as an example. Other examples may differ from what is described with respect to FIG. 5.

As described in connection with FIGS. 4 and 5, a handover procedure may allow a UE to move from a first cell to a second cell based at least in part on L1/L2 measurements with reduced overhead relative to the UE waiting to receive an RRC configuration for the second cell. However, during an interruption time associated with transmitting the signaling, communications between the serving cell and the UE may be disrupted. The network node may not be aware of a duration of the interruption time based at least in part on being unaware of UE capabilities associated with tuning, processing, and/or retuning to the serving cell, among other examples. This may cause communication errors, skipping in a stream of data, and/or a loss of an application layer connection, among other examples.

In some aspects described herein, a UE may receive LTM-based configurations of one or more neighbor cells. The UE may identify latency and/or interruption information associated with the LTM-based configurations (e.g., different values associated with individual LTM-based configurations) and indicate the latency and/or interruption information to a network node associated with a serving cell. In this way, the network node may identify a minimum interruption and/or latency for the UE to transmit a RACH communication to a neighbor cell of the one or more neighbor cells and return to availability for communications via the serving cell.

In some aspects, a network node associated with a serving cell may query a UE for information associated with a physical downlink control channel (PDCCH)-order-based UE physical random access channel (PRACH) scheduling to a non-serving cell or SCell without a physical uplink control channel (PUCCH) and/or a physical uplink shared channel (PUSCH) configured. For example, the network node may request information for a set of carrier aggregation and/or uplink configurations and a list of provided cells (non-serving cell or SCells without PUCCH and/or PUSCH configured) with PRACH configurations.

In some aspects, a neighbor cell may include one or more SCells of a serving cell (e.g., the UE may attempt to promote an SCell to a PCell) or a non-serving cell. If the SCell (e.g., configured as one of LTM candidate cells) does not have UL (e.g., DL-only SCell), the UE may use a RACH preparation time, which may cause interruptions in communications with a PCell. In this way, a non-serving cell or an SCell may be a considered a neighbor cell for LTM-based RACH communications (e.g., with a PRACH configuration).

The information may include information that the network node can use to derive a minimum latency from a slot at which the network node transmits the PDCCH that triggers a PRACH (or other RACH) communication to respective neighbor cells in the list of provided cells, to a slot where the UE supports transmission of the triggered PRACH communication to the respective neighbor cells. In some aspects, the information may include a total delay or a part of the total delay (e.g., if remaining parts of the total delay are known to the serving cell). For example, parts of the total delay that are not indicated may not be different from those defined for PDCCH-order-based PRACH transmission to serving cells with PRACH configurations.

In some aspects, the information may include interruption information. For example, the information may indicate whether PRACH preparation and/or execution causes interruption associated with an execution delay. The information may differentiate whether the interruption is associated with uplink communications and/or downlink communications. The information may indicate a set of serving cells and/or bands that may be affected by an indicated interruption. In some aspects, the information may include information about delay and/or interruption that may occur from a slot when the UE transmits the PRACH communication to a slot when the UE supports normal operations for communication with the serving cell (e.g. PDCCH, physical downlink shared channel (PDSCH), and/or channel state information (CSI)-reference signal (RS) reception and uplink transmissions from or to the serving cells) with the indicated serving cells.

In some examples, a UE may receive, from a current serving cell, an RRC message (e.g. RRCReconfiguration) that includes a list of (LTM candidate) cells for fast mobility that can be performed in a lower layer (e.g., L1/L2-physical layer/medium access control (MAC) layer). For all or some of the cells in the list, the UE may receive additional information (e.g., in the same RRC message) about PRACH configurations for the respective cells. The RRC message may also include an information element (IE) that indicates a request for information associated with a gap for LTM PRACH transmission (e.g., needForGapForLTMPRACH).

The UE may transmit a report (e.g., an RRCReconfigurationComplete communication) that indicates a list of candidate cells associated with interruptions to the serving cell (e.g., may be one or more serving cells) for transmission of a PRACH communication. The report may additionally include an interruption length (e.g., measured in time and/or time resources of a communication protocol, such as symbols, slots, subframes, or frames, among other examples) for each candidate cell at an indicated carrier aggregation and/or uplink configuration. The interruption length may be equal to or smaller than a PRACH transmission execution delay from the reception of a PDCCH that triggers PRACH to one of the PRACH cells in the report. The interruption information for uplink communications may the same or different from interruption information for downlink communications. Candidate cells that can be interrupted by PRACH transmission may be serving cells in a specific band (e.g. intra-band serving cells with the PRACH cell), and the information may be additionally included in an RRC message from UE (e.g., the report).

Based at least in part on the UE indicating the latency and/or the interruption information to the network node, the described techniques can be used to improve latency for the UE to transmit RACH communications to neighbor cells and/or reduce an interruption length for communications with the UE via the serving cell, in association with transmitting the RACH communications. For example, based at least in part on the network node being aware of a duration of the interruption time and/or latency, the network node may reduce communication errors, skipping in a stream of data, and/or a loss of an application layer connection, among other examples.

FIG. 6 is a diagram of an example 600 associated with latency and interruption information for LTM, in accordance with the present disclosure. As shown in FIG. 6, a network node (e.g., network node 110, a CU, a DU, and/or an RU) may communicate with a UE (e.g., UE 120). In some aspects, the network node and the UE may be part of a wireless network (e.g., wireless network 100). The UE and the network node may have established a wireless connection prior to operations shown in FIG. 6.

In some aspects, the configuration information may indicate one or more candidate configurations and/or communication parameters. In some aspects, the one or more candidate configurations and/or communication parameters may be selected, activated, and/or deactivated by a subsequent indication. For example, the subsequent indication may select a candidate configuration and/or communication parameter from the one or more candidate configurations and/or communication parameters. In some aspects, the subsequent indication (e.g., an indication described herein) may include a dynamic indication, such as one or more MAC CEs and/or one or more downlink control information (DCI) messages, among other examples.

In some aspects, the configuration information may indicate that the UE is to transmit an indication of support for LTM. In some aspects, the configuration information may indicate that the UE is to transmit an indication of support for reporting latencies and/or interruption information associated with candidate cells and/or associated configurations for transmitting RACH communications in association with LTM.

The UE may configure itself based at least in part on the configuration information. In some aspects, the UE may be configured to perform one or more operations described herein based at least in part on the configuration information.

As shown by reference number 610, the UE may transmit, and the network node may receive, a capabilities report. The capabilities report may indicate whether the UE supports a feature and/or one or more parameters related to the feature. For example, the capability information may indicate a capability and/or one or more parameters of the capability for LTM. As another example, the capabilities report may indicate a capability and/or one or more parameters for reporting latencies and/or interruption information associated with transmitting a RACH communication in association with LTM. One or more operations described herein may be based on capability information of the capabilities report. For example, the UE may perform a communication in accordance with the capability information, or may receive configuration information that is in accordance with the capability information.

In some aspects, the configuration information described in connection with reference number 605 and/or the capabilities report may include information transmitted via multiple communications. Additionally, or alternatively, the network node may transmit the configuration information, or a communication including at least a portion of the configuration information, before and/or after the UE transmits the capabilities report. For example, the network node may transmit a first portion of the configuration information before the capabilities report, the UE may transmit at least a portion of the capabilities report, and the network node may transmit a second portion of the configuration information after receiving the capabilities report.

As shown by reference number 615, the UE may receive, and the network node may transmit, an indication of LTM-based configurations (e.g., LTM-based configurations of one or more neighbor cells) and/or a request for an indication of a set of latency information (e.g., one or more latencies) and/or a set of interruption information associated with the LTM-based configurations. For example, the LTM-based configurations may include a first configuration for transmitting a RACH communication to a first neighbor cell (e.g., a first candidate cell for LTM) and/or a second configuration for transmitting a RACH communication to a second neighbor cell (e.g., a second candidate cell for LTM), among other examples. In some aspects where the network node also transmits a request for the indication of the set of one or more latencies and/or interruption information, the request may be associated with a request for a latency and/or an interruption length for each of the LTM-based configurations.

In some aspects, a neighbor cell may include one or more SCells of a serving cell (e.g., the UE may attempt to promote an SCell to a primary cell (PCell)) or a non-serving cell. In some aspects, the UE may receive LTM-based configurations for one or more SCells of the serving cell and/or non-serving cells.

As shown by reference number 620, the UE may transmit, and the network node may receive, an indication of the set of one or more latencies and/or the set of interruption information. In some aspects, the UE may transmit the indication based at least in part on receiving the request described in connection with reference number 615 or independently from the request (e.g., in the absence of the request). For example, the UE may transmit the indication based at least in part on receiving the indication of the LTM-based configurations, based at least in part on the indication of the LTM-based configurations indicating an update to a previously indicated set of LTM-based configurations, and/or expiration of a timer associated with a most recent indication of the set of latencies and/or interruption information, among other examples.

The set of one or more latencies and/or the set of interruption information may be associated with transmitting RACH communications associated with respective configurations of the LTM-based configurations of the one or more neighbor cells.

In some aspects, the latency may indicate a length of time from UE reception of an indication to transmit a RACH communication to a neighbor cell and the transmission of the RACH communication to the neighbor cell. In some aspects, the latency may indicate a time from an end of a PDCCH slot that triggers the RACH communication to one or more candidate cells to an earliest slot where the UE is ready to transmit the RACH communication (e.g., a PRACH communication). In some aspects, the latency information may represent only a part of the overall latency if other components in the latency are already known to the serving cell.

In some aspects, interruption information may include an interruption length associated with transmitting a RACH communication to respective neighbor cells (LTM cells). The interruption length may be different for different cells depending on, for example, whether a victim cell is in a same band as a candidate cell. The interruption information may include an interruption starting point with respect to either the end of PDCCH (e.g., that triggers the RACH communication to one or more neighbor cells) reception slot or the start of a selected RACH occasion (RO). This may be used to specify a location of an interruption window in a time domain within a delay from the PDCCH to the RO. The interruption information may include an indication of interruption bands (e.g., indicating whether the interruption is confined within the same band (intra-band) or across-bands) and/or an interruption direction (e.g., uplink only, downlink only, or both uplink and downlink of the victim cells and/or the serving cell for which interruption is caused).

In some aspects, the interruption length may indicate a length of time from UE reception of the indication to transmit the RACH communication to the neighbor cell and the availability of the UE to communicate with the network node via a serving cell. In some aspects, the interruption length may indicate a length of time from transmission of the RACH communication to the neighbor cell and the availability of the UE to communicate with the network node via a serving cell. In some aspects, the interruption may include time from before transmission of the RACH communication (e.g., due to RACH transmission preparation) after an end of a PDCCH slot that indicates to receive the RACH communication, during transmission of the RACH communication, and/or after transmission of the RACH communication (e.g., associated with a time to tune back to the serving cell) and before the UE is ready to communicate via the serving cell.

In some aspects, the interruption information may be associated with the length of time before transmission of the PRACH communication and/or the length of time after transmission of the RACH communication. In some aspects, interruption lengths from before the transmission and after the transmission may be different. If the lengths are not identical, the UE may indicate the interruption lengths and/or associated information separately.

In some aspects, an interruption length associated with an LTM-based configuration and/or a neighbor cell network node may be based at least in part on an associated latency (e.g., a latency for transmitting an associated RACH communication), a tuning time associated with switching to a bandwidth or bandwidth part (BWP) associated with a neighbor cell associated with a respective interruption length, a retuning time associated with switching from the bandwidth or BWP associated with the neighbor cell to a serving cell, and/or a delay between retuning and a subsequent RACH occasion, among other examples.

In some aspects, the indication of the set of one or more latencies and/or the set of interruption information may further indicate, for individual LTM-based configurations, whether preparation for the RACH communication is associated with an interruption with a serving cell, whether execution of the RACH communication is associated with the interruption, whether the interruption is associated with one or more of downlink communications or uplink communications, one or more serving cells associated with the interruption, and/or one or more bands associated with the interruption, among other examples. In some aspects, the indication may include information for the network node to use to identify a total latency and/or interruption length.

As shown by reference number 625, the network node may identify timing for a RACH communication to one or more neighbor cells. For example, the network node may identify timing for UE transmission of a RACH communication to one or more neighbor cells. The network node may select the timing for the UE transmission to support availability of the UE to receive a high-priority communication via the serving cell and/or to coordinate with a timing of RACH occasions of the one or more neighbor cells. For example, the network node may transmit the indication to transmit the RACH communication at a time that allows the UE, based at least in part on latency, to transmit the RACH communication with a minimal delay of waiting for a subsequent RACH occasion.

In some aspects, the one or more neighbor cells may include one or more SCells of the serving cell (e.g., the UE may attempt to promote an SCell to the PCell) or a non-serving cell (e.g., a cell associated with a neighbor network node). In some aspects, the UE may receive LTM-based configurations for one or more SCells of the serving cell and/or non-serving cells.

As shown by reference number 630, the network node may transmit, and the UE may receive, an indication to transmit a RACH communication to one or more neighbor cells. In some aspects, the network node may transmit the indication to transmit the RACH communication to at least one of the one or more neighbor cells based at least in part on the indication of the one or more of the set of one or more latencies or the set of interruption information.

As shown by reference number 635, the UE may transmit the RACH communication to one or more neighbor cell network nodes. For example, the UE may transmit a same RACH communication (e.g., with different scrambling or other transmission parameters) to multiple neighbor cell network nodes or may transmit different RACH communications to different neighbor cell network nodes (e.g., a first RACH communication to a first neighbor cell network node and a second RACH communication to a second neighbor cell network node, among other examples).

In some aspects, the UE may transmit the RACH communication at a time that is offset from receiving the indication to transmit the RACH communication by an amount of time that is at least as long as a latency associated with the at least one of the one or more neighbor cells. For example, the UE may transmit a first RACH communication to a first neighbor cell network node at a first time that has a first offset from receiving the indication to transmit the RACH communication, with the first offset being at least at long as a reported latency for transmitting the RACH communication using a first configuration associated with the first neighbor cell network node. Similarly, the UE may transmit a second RACH communication to a second neighbor cell network node at a second time that has a second offset from receiving the indication to transmit the RACH communication, with the second offset being at least at long as a reported latency for transmitting the RACH communication using a second configuration associated with the second neighbor cell network node. In some aspects, transmitting the first RACH communication and the second RACH communication may be based at least in part on a same indication to transmit the RACH communication. In some aspects, the first offset and the second offset may be different.

In some aspects, communications between the UE and the network node may be interrupted in association with transmission of the RACH communication described in connection with reference number 635. For example, the UE may be unable to transmit via one or more serving cells associated with the network node and/or the UE may be unable to receive via one or more serving cells associated with the network node.

As shown by reference number 640, the network node may transmit a scheduling indication (e.g., scheduling uplink and/or downlink communications) and/or communications after an interruption associated with the RACH communication.

In some aspects, the network node may iteratively perform one or more of operations 625-640 until a suitable neighbor cell is found for a cell switch (e.g., handover). In some aspects, the one or more neighbor cell network nodes may forward information associated with the RACH communication of reference number 635 to the network node for use by the network node to identify a suitable neighbor cell.

Based at least in part on the UE indicating the latency and/or the interruption information to the network node, the described techniques can be used to improve latency for the UE to transmit RACH communications to neighbor cells and/or reduce an interruption length for communications with the UE via the serving cell, in association with transmitting the RACH communications. For example, based at least in part on the network node being aware of a duration of the interruption time and/or latency, the network node may reduce communication errors, skipping in a stream of data, and/or a loss of an application layer connection, among other examples.

As indicated above, FIG. 6 is provided as an example. Other examples may differ from what is described with respect to FIG. 6.

FIG. 7 is a diagram illustrating an example process 700 performed, for example, at a UE or an apparatus of a UE, in accordance with the present disclosure. Example process 700 is an example where the apparatus or the UE (e.g., UE 120) performs operations associated with latency and interruption information for LTM.

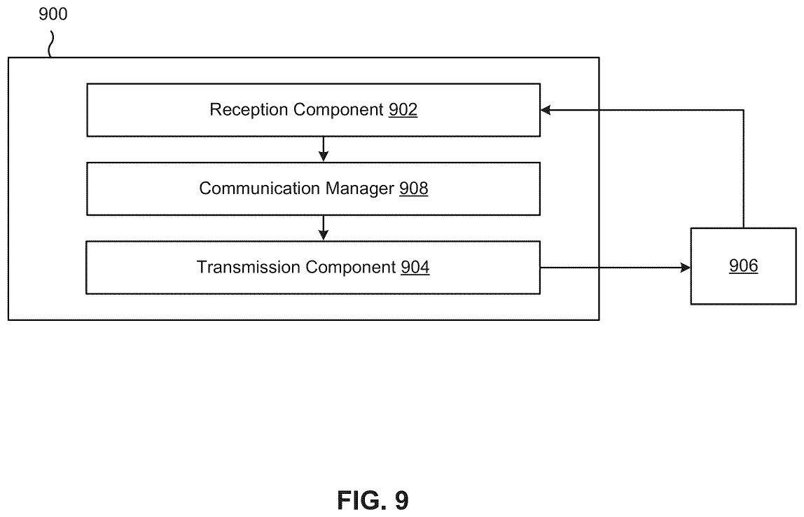

As shown in FIG. 7, in some aspects, process 700 may include receiving LTM-based configurations of one or more neighbor cells (block 710). For example, the UE (e.g., using reception component 902 and/or communication manager 906, depicted in FIG. 9) may receive LTM-based configurations of one or more neighbor cells, as described above.

As further shown in FIG. 7, in some aspects, process 700 may include transmitting an indication of one or more of a set of one or more latencies or a set of interruption information in association with transmitting RACH communications associated with respective configurations of the LTM-based configurations of the one or more neighbor cells (block 720). For example, the UE (e.g., using transmission component 904 and/or communication manager 906, depicted in FIG. 9) may transmit an indication of one or more of a set of one or more latencies or a set of interruption information in association with transmitting RACH communications associated with respective configurations of the LTM-based configurations of the one or more neighbor cells, as described above.

Process 700 may include additional aspects, such as any single aspect or any combination of aspects described below and/or in connection with one or more other processes described elsewhere herein.

In a first aspect, process 700 includes receiving a request for the one or more of the set of one or more latencies or the set of interruption information.

In a second aspect, alone or in combination with the first aspect, process 700 includes transmitting an indication of a capability to transmit the indication of the one or more of the set of one or more latencies or the set of interruption information.

In a third aspect, alone or in combination with one or more of the first and second aspects, process 700 includes receiving, based at least in part on the indication of the one or more of the set of one or more latencies or the set of interruption information, an indication to transmit the RACH communication to at least one of the one or more neighbor cells.

In a fourth aspect, alone or in combination with one or more of the first through third aspects, process 700 includes transmitting the RACH communication to at least one of the one or more neighbor cells.

In a fifth aspect, alone or in combination with one or more of the first through fourth aspects, transmitting the RACH communication comprises transmitting the RACH communication at a time that is offset from an indication to transmit the RACH communication by an amount of time that is at least as long as a latency associated with the at least one of the one or more neighbor cells.

In a sixth aspect, alone or in combination with one or more of the first through fifth aspects, process 700 includes receiving, after transmitting the RACH communication and based at least in part on the indication of the one or more of the set of one or more latencies or the set of interruption information, a communication via a serving cell.

In a seventh aspect, alone or in combination with one or more of the first through sixth aspects, the set of interruption information comprises one or more interruption lengths that include time associated with one or more of an associated latency, a tuning time associated with switching to a bandwidth or BWP associated with a neighbor cell associated with a respective interruption length, a retuning time associated with switching from the bandwidth or BWP associated with the neighbor cell to a serving cell, or a delay between retuning and a subsequent RACH occasion.

In an eighth aspect, alone or in combination with one or more of the first through seventh aspects, the indication of the one or more of the set of one or more latencies or the set of interruption information comprises respective indications, for the respective configurations, of one or more of whether preparation for the RACH communication is associated with an interruption with a serving cell, whether execution of the RACH communication is associated with the interruption, whether the interruption is associated with one or more of downlink communications or uplink communications, one or more serving cells associated with the interruption, a starting time of the interruption, or one or more bands associated with the interruption.

In a ninth aspect, alone or in combination with one or more of the first through eighth aspects, the set of interruption information comprises a set of one or more interruption lengths associated with interruption of communications via a serving cell, and the one or more interruption lengths are identified from a starting time that is associated with one or more of reception of an indication to transmit the RACH communication or transmission of the RACH communication.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram illustrating an example process 800 performed, for example, at a network node or an apparatus of a network node, in accordance with the present disclosure. Example process 800 is an example where the apparatus or the network node (e.g., network node 110) performs operations associated with latency and interruption information for LTM.

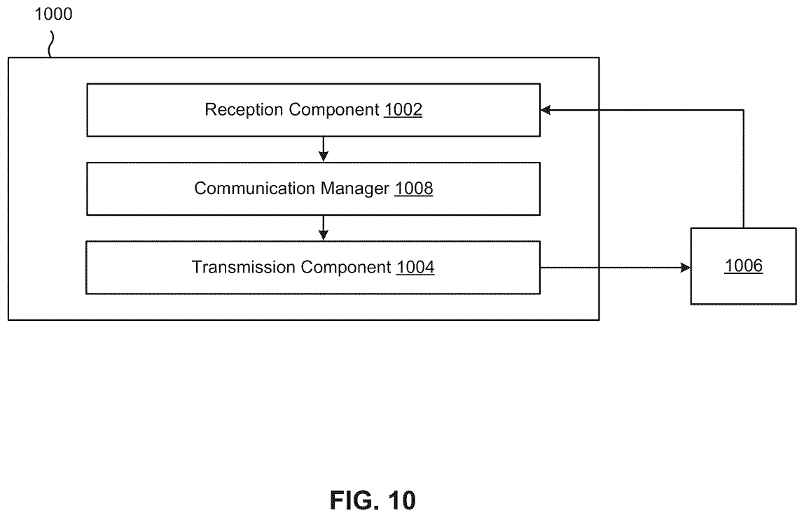

As shown in FIG. 8, in some aspects, process 800 may include transmitting, to a UE, LTM-based configurations of one or more neighbor cells (block 810). For example, the network node (e.g., using transmission component 1004 and/or communication manager 1006, depicted in FIG. 10) may transmit, to a UE, LTM-based configurations of one or more neighbor cells, as described above.

As further shown in FIG. 8, in some aspects, process 800 may include receiving an indication of one or more of a set of one or more latencies or a set of interruption information in association with the UE transmitting RACH communications associated with respective configurations of the LTM-based configurations of the one or more neighbor cells (block 820). For example, the network node (e.g., using reception component 1002 and/or communication manager 1006, depicted in FIG. 10) may receive an indication of one or more of a set of one or more latencies or a set of interruption information in association with the UE transmitting RACH communications associated with respective configurations of the LTM-based configurations of the one or more neighbor cells, as described above.

Process 800 may include additional aspects, such as any single aspect or any combination of aspects described below and/or in connection with one or more other processes described elsewhere herein.

In a first aspect, process 800 includes transmitting a request for the one or more of the set of one or more latencies or the set of interruption information.

In a second aspect, alone or in combination with the first aspect, process 800 includes receiving an indication of a capability of the UE to transmit the indication of the one or more of the set of one or more latencies or the set of interruption information.

In a third aspect, alone or in combination with one or more of the first and second aspects, process 800 includes transmitting, based at least in part on the indication of the one or more of the set of one or more latencies or the set of interruption information, an indication to transmit the RACH communication to a neighbor cell of the one or more neighbor cells.

In a fourth aspect, alone or in combination with one or more of the first through third aspects, transmitting the indication to transmit the RACH communication comprises transmitting the indication at a time associated with a reduction of an interruption length in association with transmission of the RACH communication to the neighbor cell.

In a fifth aspect, alone or in combination with one or more of the first through fourth aspects, process 800 includes transmitting, after transmitting the indication to transmit the RACH communication and based at least in part on the indication of the one or more of the set of one or more latencies or the set of interruption information, a communication to the UE.

In a sixth aspect, alone or in combination with one or more of the first through fifth aspects, the interruption information comprises one or more interruption lengths include time associated with one or more of an associated latency, a tuning time associated with switching to a bandwidth or BWP associated with a neighbor cell associated with a respective interruption length, a retuning time associated with switching from the bandwidth or BWP associated with the neighbor cell to a serving cell, or a delay between retuning and a subsequent RACH occasion.

In a seventh aspect, alone or in combination with one or more of the first through sixth aspects, the indication of the one or more of the set of one or more latencies or the set of interruption information comprises respective indications, for the respective configurations, of one or more of whether preparation for the RACH communication is associated with an interruption with a serving cell, whether execution of the RACH communication is associated with the interruption, whether the interruption is associated with one or more of downlink communications or uplink communications, one or more serving cells associated with the interruption, a starting time of the interruption, or one or more bands associated with the interruption.

In an eighth aspect, alone or in combination with one or more of the first through seventh aspects, the set of interruption information comprises a set of one or more interruption lengths associated with interruption of communications via a serving cell, and wherein the one or more interruption lengths are identified from a starting time that is associated with one or more of reception of an indication to transmit the RACH communication or transmission of the RACH communication.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram of an example apparatus 900 for wireless communication, in accordance with the present disclosure. The apparatus 900 may be a UE, or a UE may include the apparatus 900. In some aspects, the apparatus 900 includes a reception component 902, a transmission component 904, and/or a communication manager 906, which may be in communication with one another (for example, via one or more buses and/or one or more other components). In some aspects, the communication manager 906 is the communication manager 140 described in connection with FIG. 1. As shown, the apparatus 900 may communicate with another apparatus 908, such as a UE or a network node (such as a CU, a DU, an RU, or a base station), using the reception component 902 and the transmission component 904.

In some aspects, the apparatus 900 may be configured to perform one or more operations described herein in connection with FIG. 6. Additionally, or alternatively, the apparatus 900 may be configured to perform one or more processes described herein, such as process 700 of FIG. 7. In some aspects, the apparatus 900 and/or one or more components shown in FIG. 9 may include one or more components of the UE described in connection with FIG. 2. Additionally, or alternatively, one or more components shown in FIG. 9 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 902 may receive communications, such as reference signals, control information, data communications, or a combination thereof, from the apparatus 908. The reception component 902 may provide received communications to one or more other components of the apparatus 900. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 900. In some aspects, the reception component 902 may include one or more antennas, one or more modems, one or more demodulators, one or more MIMO detectors, one or more receive processors, one or more controllers/processors, one or more memories, or a combination thereof, of the UE described in connection with FIG. 2.

The transmission component 904 may transmit communications, such as reference signals, control information, data communications, or a combination thereof, to the apparatus 908. In some aspects, one or more other components of the apparatus 900 may generate communications and may provide the generated communications to the transmission component 904 for transmission to the apparatus 908. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 908. In some aspects, the transmission component 904 may include one or more antennas, one or more modems, one or more modulators, one or more transmit MIMO processors, one or more transmit processors, one or more controllers/processors, one or more memories, or a combination thereof, of the UE described in connection with FIG. 2. In some aspects, the transmission component 904 may be co-located with the reception component 902 in one or more transceivers.

The communication manager 906 may support operations of the reception component 902 and/or the transmission component 904. For example, the communication manager 906 may receive information associated with configuring reception of communications by the reception component 902 and/or transmission of communications by the transmission component 904. Additionally, or alternatively, the communication manager 906 may generate and/or provide control information to the reception component 902 and/or the transmission component 904 to control reception and/or transmission of communications.

The reception component 902 may receive LTM-based configurations of one or more neighbor cells. The transmission component 904 may transmit an indication of one or more of a set of one or more latencies or a set of interruption information in association with transmitting RACH communications associated with respective configurations of the LTM-based configurations of the one or more neighbor cells.

The reception component 902 may receive a request for the one or more of the set of one or more latencies or the set of interruption information.

The transmission component 904 may transmit an indication of a capability to transmit the indication of the one or more of the set of one or more latencies or the set of interruption information.

The reception component 902 may receive, based at least in part on the indication of the one or more of the set of one or more latencies or the set of interruption information, an indication to transmit the RACH communication to at least one of the one or more neighbor cells.

The transmission component 904 may transmit the RACH communication to at least one of the one or more neighbor cells.

The reception component 902 may receive, after transmitting the RACH communication and based at least in part on the indication of the one or more of the set of one or more latencies or the set of interruption information, a communication via a serving cell.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

FIG. 10 is a diagram of an example apparatus 1000 for wireless communication, in accordance with the present disclosure. The apparatus 1000 may be a network node, or a network node may include the apparatus 1000. In some aspects, the apparatus 1000 includes a reception component 1002, a transmission component 1004, and/or a communication manager 1006, which may be in communication with one another (for example, via one or more buses and/or one or more other components). In some aspects, the communication manager 1006 is the communication manager 150 described in connection with FIG. 1. As shown, the apparatus 1000 may communicate with another apparatus 1008, such as a UE or a network node (such as a CU, a DU, an RU, or a base station), using the reception component 1002 and the transmission component 1004.

In some aspects, the apparatus 1000 may be configured to perform one or more operations described herein in connection with FIG. 6. Additionally, or alternatively, the apparatus 1000 may be configured to perform one or more processes described herein, such as process 800 of FIG. 8. In some aspects, the apparatus 1000 and/or one or more components shown in FIG. 10 may include one or more components of the network node described in connection with FIG. 2. Additionally, or alternatively, one or more components shown in FIG. 10 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1002 may receive communications, such as reference signals, control information, data communications, or a combination thereof, from the apparatus 1008. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1000. In some aspects, the reception component 1002 may include one or more antennas, one or more modems, one or more demodulators, one or more MIMO detectors, one or more receive processors, one or more controllers/processors, one or more memories, or a combination thereof, of the network node described in connection with FIG. 2. In some aspects, the reception component 1002 and/or the transmission component 1004 may include or may be included in a network interface. The network interface may be configured to obtain and/or output signals for the apparatus 1000 via one or more communications links, such as a backhaul link, a midhaul link, and/or a fronthaul link.

The transmission component 1004 may transmit communications, such as reference signals, control information, data communications, or a combination thereof, to the apparatus 1008. In some aspects, one or more other components of the apparatus 1000 may generate communications and may provide the generated communications to the transmission component 1004 for transmission to the apparatus 1008. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1008. In some aspects, the transmission component 1004 may include one or more antennas, one or more modems, one or more modulators, one or more transmit MIMO processors, one or more transmit processors, one or more controllers/processors, one or more memories, or a combination thereof, of the network node described in connection with FIG. 2. In some aspects, the transmission component 1004 may be co-located with the reception component 1002 in one or more transceivers.

The communication manager 1006 may support operations of the reception component 1002 and/or the transmission component 1004. For example, the communication manager 1006 may receive information associated with configuring reception of communications by the reception component 1002 and/or transmission of communications by the transmission component 1004. Additionally, or alternatively, the communication manager 1006 may generate and/or provide control information to the reception component 1002 and/or the transmission component 1004 to control reception and/or transmission of communications.

The transmission component 1004 may transmit, to a UE, LTM-based configurations of one or more neighbor cells. The reception component 1002 may receive an indication of one or more of a set of one or more latencies or a set of interruption information in association with the UE transmitting RACH communications associated with respective configurations of the LTM-based configurations of the one or more neighbor cells.

The transmission component 1004 may transmit a request for the one or more of the set of one or more latencies or the set of interruption information.

The reception component 1002 may receive an indication of a capability of the UE to transmit the indication of the one or more of the set of one or more latencies or the set of interruption information.

The transmission component 1004 may transmit, based at least in part on the indication of the one or more of the set of one or more latencies or the set of interruption information, an indication to transmit the RACH communication to a neighbor cell of the one or more neighbor cells.

The transmission component 1004 may transmit, after transmitting the indication to transmit the RACH communication and based at least in part on the indication of the one or more of the set of one or more latencies or the set of interruption information, a communication to the UE.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

The following provides an overview of some Aspects of the present disclosure:

Aspect 1: A method of wireless communication performed by a user equipment (UE), comprising: receiving layer-1/2-triggered mobility (LTM)-based configurations of one or more neighbor cells; and transmitting an indication of one or more of a set of one or more latencies or a set of interruption information in association with transmitting random access channel (RACH) communications associated with respective configurations of the LTM-based configurations of the one or more neighbor cells.

Aspect 2: The method of Aspect 1, further comprising: receiving a request for the one or more of the set of one or more latencies or the set of interruption information.

Aspect 3: The method of any of Aspects 1-2, further comprising: transmitting an indication of a capability to transmit the indication of the one or more of the set of one or more latencies or the set of interruption information.

Aspect 4: The method of any of Aspects 1-3, further comprising: receiving, based at least in part on the indication of the one or more of the set of one or more latencies or the set of interruption information, an indication to transmit the RACH communication to at least one of the one or more neighbor cells.

Aspect 5: The method of any of Aspects 1-4, further comprising transmitting the RACH communication to at least one of the one or more neighbor cells.

Aspect 6: The method of Aspect 5, wherein transmitting the RACH communication comprises transmitting the RACH communication at a time that is offset from an indication to transmit the RACH communication by an amount of time that is at least as long as a latency associated with the at least one of the one or more neighbor cells.

Aspect 7: The method of any of Aspects 5-6, further comprising: receiving, after transmitting the RACH communication and based at least in part on the indication of the one or more of the set of one or more latencies or the set of interruption information, a communication via a serving cell.

Aspect 8: The method of any of Aspects 1-7, wherein the interruption information comprises one or more interruption lengths that include time associated with one or more of: an associated latency, a tuning time associated with switching to a bandwidth or bandwidth part (BWP) associated with a neighbor cell associated with a respective interruption length, a retuning time associated with switching from the bandwidth or BWP associated with the neighbor cell to a serving cell, or a delay between retuning and a subsequent RACH occasion.

Aspect 9: The method of any of Aspects 1-8, wherein the indication of the one or more of the set of one or more latencies or the set of interruption information comprises respective indications, for the respective configurations, of one or more of: whether preparation for the RACH communication is associated with an interruption with a serving cell, whether execution of the RACH communication is associated with the interruption, whether the interruption is associated with one or more of downlink communications or uplink communications, one or more serving cells associated with the interruption, a starting time of the interruption, or one or more bands associated with the interruption.

Aspect 10: The method of any of Aspects 1-9, wherein the set of interruption information comprises a set of one or more interruption lengths that are associated with interruption of communications via a serving cell, and wherein the one or more interruption lengths are identified from a starting time that is associated with one or more of reception of an indication to transmit the RACH communication or transmission of the RACH communication.

Aspect 11: A method of wireless communication performed by a network node, comprising: transmitting, to a user equipment (UE) layer-1/2-triggered mobility (LTM)-based configurations of one or more neighbor cells; and receiving an indication of one or more of a set of one or more latencies or a set of interruption information in association with the UE transmitting random access channel (RACH) communications associated with respective configurations of the LTM-based configurations of the one or more neighbor cells.

Aspect 12: The method of Aspect 11, further comprising: transmitting a request for the one or more of the set of one or more latencies or the set of interruption information.

Aspect 13: The method of any of Aspects 11-12, further comprising: receiving an indication of a capability of the UE to transmit the indication of the one or more of the set of one or more latencies or the set of interruption information.

Aspect 14: The method of any of Aspects 11-13, further comprising: transmitting, based at least in part on the indication of the one or more of the set of one or more latencies or the set of interruption information, an indication to transmit the RACH communication to a neighbor cell of the one or more neighbor cells.

Aspect 15: The method of Aspect 14, wherein transmitting the indication to transmit the RACH communication comprises: transmitting the indication at a time associated with a reduction of an interruption length in association with transmission of the RACH communication to the neighbor cell.

Aspect 16: The method of any of Aspects 14-15, further comprising: transmitting, after transmitting the indication to transmit the RACH communication and based at least in part on the indication of the one or more of the set of one or more latencies or the set of interruption information, a communication to the UE.

Aspect 17: The method of any of Aspects 11-16, wherein the interruption information comprises one or more interruption lengths that include time associated with one or more of: an associated latency, a tuning time associated with switching to a bandwidth or bandwidth part (BWP) associated with a neighbor cell associated with a respective interruption length, a retuning time associated with switching from the bandwidth or BWP associated with the neighbor cell to a serving cell, or a delay between retuning and a subsequent RACH occasion.

Aspect 18: The method of any of Aspects 11-17, wherein the indication of the one or more of the set of one or more latencies or the set of interruption information comprises respective indications, for the respective configurations, of one or more of: whether preparation for the RACH communication is associated with an interruption with a serving cell, whether execution of the RACH communication is associated with the interruption, whether the interruption is associated with one or more of downlink communications or uplink communications, one or more serving cells associated with the interruption, a starting time of the interruption, or one or more bands associated with the interruption.

Aspect 19: The method of any of Aspects 11-18, wherein the set of interruption information comprises a set of one or more interruption lengths associated with interruption of communications via a serving cell, and wherein the set of one or more interruption lengths are identified from a starting time that is associated with one or more of reception of an indication to transmit the RACH communication or transmission of the RACH communication.

Aspect 20: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-19.

Aspect 21: An apparatus for wireless communication at a device, the apparatus comprising one or more memories and one or more processors coupled to the one or more memories, the one or more processors configured to cause the device to perform the method of one or more of Aspects 1-19.

Aspect 22: An apparatus for wireless communication, the apparatus comprising at least one means for performing the method of one or more of Aspects 1-19.

Aspect 23: A non-transitory computer-readable medium storing code for wireless communication, the code comprising instructions executable by one or more processors to perform the method of one or more of Aspects 1-19.

Aspect 24: A non-transitory computer-readable medium storing a set of instructions for wireless communication, the set of instructions comprising one or more instructions that, when executed by one or more processors of a device, cause the device to perform the method of one or more of Aspects 1-19.

Aspect 25: A device for wireless communication, the device comprising a processing system that includes one or more processors and one or more memories coupled with the one or more processors, the processing system configured to cause the device to perform the method of one or more of Aspects 1-19.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices, for example, a combination of a DSP and a microprocessor, a plurality of microprocessors, one or more microprocessors in conjunction with a DSP core, or any other such configuration. In some aspects, particular processes and methods may be performed by circuitry that is specific to a given function.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a +a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A user equipment (UE) for wireless communication, comprising:
one or more memories; and
one or more processors, coupled to the one or more memories, configured to:
receive layer-1/2-triggered mobility (LTM)-based configurations of one or more neighbor cells; and
transmit an indication of one or more of a set of one or more latencies or a set of interruption information in association with transmitting random access channel (RACH) communications associated with respective configurations of the LTM-based configurations of the one or more neighbor cells.

2. The UE of claim 1, wherein the one or more processors are further configured to:
receive a request for the one or more of the set of one or more latencies or the set of interruption information.

3. The UE of claim 1, wherein the one or more processors are further configured to:
transmit an indication of a capability to transmit the indication of the one or more of the set of one or more latencies or the set of interruption information.

4. The UE of claim 1, wherein the one or more processors are further configured to:
receive, based at least in part on the indication of the one or more of the set of one or more latencies or the set of interruption information, an indication to transmit the RACH communication to at least one of the one or more neighbor cells.

5. The UE of claim 1, wherein the one or more processors are further configured to transmit the RACH communication to at least one of the one or more neighbor cells.

6. The UE of claim 5, wherein the one or more processors, to transmit the RACH communication, are configured to transmit the RACH communication at a time that is offset from an indication to transmit the RACH communication by an amount of time that is at least as long as a latency associated with the at least one of the one or more neighbor cells.

7. The UE of claim 5, wherein the one or more processors are further configured to:
receive, after transmitting the RACH communication and based at least in part on the indication of the one or more of the set of one or more latencies or the set of interruption information, a communication via a serving cell.

8. The UE of claim 1, wherein the set of interruption information comprises one or more interruption lengths that include time associated with one or more of:
an associated latency,
a tuning time associated with switching to a bandwidth or bandwidth part (BWP) associated with a neighbor cell associated with a respective interruption length,
a retuning time associated with switching from the bandwidth or BWP associated with the neighbor cell to a serving cell, or
a delay between retuning and a subsequent RACH occasion.

9. The UE of claim 1, wherein the indication of the one or more of the set of one or more latencies or the set of interruption information comprises respective indications, for the respective configurations, of one or more of:
whether preparation for the RACH communication is associated with an interruption with a serving cell,
whether execution of the RACH communication is associated with the interruption,
whether the interruption is associated with one or more of downlink communications or uplink communications,
one or more serving cells associated with the interruption,
a starting time of the interruption, or
one or more bands associated with the interruption.

10. The UE of claim 1, wherein the set of interruption information comprises a set of one or more interruption lengths associated with interruption of communications via a serving cell, and
wherein the one or more interruption lengths are identified from a starting time that is associated with one or more of reception of an indication to transmit the RACH communication or transmission of the RACH communication.

11. A network node for wireless communication, comprising:
one or more memories; and
one or more processors, coupled to the one or more memories, configured to:
transmit, to a user equipment (UE), layer-1/2-triggered mobility (LTM)-based configurations of one or more neighbor cells; and
receive an indication of one or more of a set of one or more latencies or a set of interruption information in association with the UE transmitting random access channel (RACH) communications associated with respective configurations of the LTM-based configurations of the one or more neighbor cells.

12. The network node of claim 11, wherein the one or more processors are further configured to:
transmit a request for the one or more of the set of one or more latencies or the set of interruption information.

13. The network node of claim 11, wherein the one or more processors are further configured to:
receive an indication of a capability of the UE to transmit the indication of the one or more of the set of one or more latencies or the set of interruption information.

14. The network node of claim 11, wherein the one or more processors are further configured to:
transmit, based at least in part on the indication of the one or more of the set of one or more latencies or the set of interruption information, an indication to transmit the RACH communication to a neighbor cell of the one or more neighbor cells.

15. A method of wireless communication performed by a user equipment (UE), comprising:
receiving layer-1/2-triggered mobility (LTM)-based configurations of one or more neighbor cells; and
transmitting an indication of one or more of a set of one or more latencies or a set of interruption information in association with transmitting random access channel (RACH) communications associated with respective configurations of the LTM-based configurations of the one or more neighbor cells.

16. The method of claim 15, further comprising:
receiving a request for the one or more of the set of one or more latencies or the set of interruption information.

17. The method of claim 15, further comprising transmitting the RACH communication to at least one of the one or more neighbor cells.

18. The method of claim 17, further comprising:
receiving, after transmitting the RACH communication and based at least in part on the indication of the one or more of the set of one or more latencies or the set of interruption information, a communication via a serving cell.

19. The method of claim 15, wherein the set of interruption information comprises one or more interruption lengths that include time associated with one or more of:
an associated latency,
a tuning time associated with switching to a bandwidth or bandwidth part (BWP) associated with a neighbor cell associated with a respective interruption length,
a retuning time associated with switching from the bandwidth or BWP associated with the neighbor cell to a serving cell, or
a delay between retuning and a subsequent RACH occasion.

20. The method of claim 15, wherein the indication of the one or more of the set of one or more latencies or the set of interruption information comprises respective indications, for the respective configurations, of one or more of:
whether preparation for the RACH communication is associated with an interruption with a serving cell,
whether execution of the RACH communication is associated with the interruption,
whether the interruption is associated with one or more of downlink communications or uplink communications,
one or more serving cells associated with the interruption,
a starting time of the interruption, or
one or more bands associated with the interruption.
